(19) United States
(12) Patent Application Publication
(10) Pub. No.: US 2019/0249073 A1
(43) Pub. Date: Aug. 15, 2019

(54) METHODS AND COMPOSITIONS OF SUBTERRANEAN FORMATION STABILIZATION

(71) Applicant: Halliburton Energy Services, Inc., Houston, TX (US)

(72) Inventors: Antonio RECIO, III, Humble, TX (US); Dipti SINGH, Kingwood, TX (US); Denise Nicole BENOIT, Houston, TX (US)

(21) Appl. No.: 16/333,518

(22) PCT Filed: Sep. 29, 2016
(86) PCT No.: PCT/US16/54338

§ 371 Date: Mar. 14, 2019

(51) Int. Cl. C09K 8/575; E21B 43/267; C09K 8/80

(52) U.S. Cl. CPC C09K 8/575; C09K 2208/10; C09K 8/805; E21B 43/267

(57) ABSTRACT

The present disclosure relates to subterranean formation operations and, more particularly, to subterranean formation stabilization using self-assembled proppant monolayers. Specifically, the present disclosure provides a “hook-and-latch” process to stabilize a formation face, such as a fracture face, by facilitating the self-assembly of a monolayer of proppant particulates, including within complex fracture networks.

### BACKGROUND

The present disclosure relates to subterranean formation operations and, more particularly, to subterranean formation stabilization using self-assembled proppant monolayers.

Subterranean wells are often stimulated by hydraulic fracturing treatments. In hydraulic fracturing treatments, a viscous treatment fluid is pumped into a portion of a subterranean formation at a rate and pressure such that the subterranean formation breaks down and one or more fractures are formed. While the treatment fluid used to initiate the fracture is generally solids-free, typically, particulate solids, such as graded sand, are introduced in a later portion of the treatment fluid and then deposited into the fracture. These particulate solids, (generally known as “proppant particulates” or, simply, “proppant”) serve to prop the fracture open (e.g., keep the fracture from fully closing) after the hydraulic pressure is removed and dissipated. By keeping the fracture from fully closing, the proppants aid in forming conductive paths through which produced fluids, such as hydrocarbons, may flow.

Hydraulic fracturing of subterranean wells can produce unconsolidated formation particulates or is performed in formations that already contain unconsolidated formation particulates. These unconsolidated particulates may migrate out of the subterranean formation and be produced with production fluids. The presence of unconsolidated particulates in a formation during production is undesirable because they may damage or abrade producing equipment or reduce well production. Additionally, unconsolidated particulates may reduce the integrity of the formation-proppant interface and result in decreased fracture width. As another example, the unconsolidated particulates may migrate into wellbore casings, perforations, or the interstitial spaces between packed proppants within a fracture and clog or they can hinder well production. As used herein, the term “unconsolidated formation particulates” or simply “nonconsolidated particulates,” and grammatical variants thereof, refers to any loose or loosely bonded particulates originating from a subterranean formation (e.g., formation fines due to breakdown or degradation of a formation) that may move through the formation with introduced or produced fluids.

Traditional methods of stabilizing a face of a formation (e.g., a fracture face) and controlling unconsolidated particulates is by contacting the face with brines, polymers, or resins, which serve to stabilize minerals thereof (e.g., clay minerals). As used herein, the term “stabilization,” and grammatical variants thereof (e.g., “stabilize,” stabilizing,” and the like), refers to making stable, reducing hydration, locking in place, and/or at least partially immobilizing unconsolidated formation particulates within a subterranean formation such that they at least partially resist or wholly resist flowing with introduced and/or produced fluids. Stabilization may, for example, prevent swelling and softening of the clay materials within a formation to reduce their production as unconsolidated particulates, thereby reducing damage associated with unconsolidated clay materials (e.g., bridging of pore throats). Such stabilization may additionally be referred to in the oil and gas industry, and herein, as “clay control” or “fines control.” The term “face,” and grammatical variants thereof, with reference to a formation refers to any surface of a subterranean formation that contacts an introduced or produced fluid therein.

The use of brines for stabilization effectively increases the force needed to detach unconsolidated particulates from the formation face and reduces osmotic forces that may cause swelling and fines migration for many minerals in traditional subterranean formations, although stabilization may itself be only temporarily effective and sensitivity to ionic concentration changes may result in even reduced effectiveness. Resins are effective stabilizers, but uniform coatings along one or more faces of a formation, particularly long intervals, can be difficult (e.g., traditional resin pills are highly viscous and coverage is thus challenging).

### BRIEF DESCRIPTION OF THE DRAWINGS

The following figures are included to illustrate certain aspects of the embodiments described herein, and should not be viewed as exclusive embodiments. The subject matter disclosed is capable of considerable modifications, alterations, combinations, and equivalents in form and function, as will occur to those skilled in the art and having the benefit of this disclosure.

FIG. 1 depicts an embodiment of a system configured for delivering various treatment fluids described herein to a downhole location, according to one or more embodiments of the present disclosure.

### SUMMARY OF THE INVENTION

The present disclosure relates to subterranean formation operations and, more particularly, to subterranean formation stabilization using self-assembled proppant monolayers.

Specifically, the present disclosure provides a “hook-and-latch” process to stabilize a formation face by facilitating the self-assembly of a monolayer of proppant particulates, including within complex fracture networks. As used herein, the term “monolayer,” and grammatical variants thereof, refers to forming a single layer of proppant particulates. Material for forming the proppant particulates is described below (e.g., sand, fly ash, drill cuttings, etc.). As used herein, the term “fracture network” refers to the access conduits, either natural or man-made or otherwise, within a subterranean formation that are in fluid communication with a wellbore penetrating the formation. The “complexity” of a fracture network refers to the amount of access conduits, man-made or otherwise, within a subterranean formation that are in fluid communication with a wellbore; the greater the amount of access conduits, the greater the complexity. A fracture network with enhanced complexity may increase the amount of produced fluids that may be recovered from a particular subterranean formation.

One or more illustrative embodiments disclosed herein are presented below. Not all features of an actual implementation are described or shown in this application for the sake of clarity. It is understood that in the development of an actual embodiment incorporating the embodiments disclosed herein, numerous implementation-specific decisions must be made to achieve the developer's goals, such as compliance with system-related, lithology-related, business-related, government-related, and other constraints, which vary by implementation and from time to time. While a developer's efforts might be complex and time-consuming, such efforts would be, nevertheless, a routine undertaking for those of ordinary skill in the art having benefit of this disclosure.

It should be noted that when “about” is provided herein at the beginning of a numerical list, the term modifies each number of the numerical list. In some numerical listings of ranges, some lower limits listed may be greater than some upper limits listed. One skilled in the art will recognize that the selected subset will require the selection of an upper limit in excess of the selected lower limit. Unless otherwise indicated, all numbers expressing quantities of ingredients, properties such as molecular weight, reaction conditions, and so forth used in the present specification and associated claims are to be understood as being modified in all instances by the term “about.” As used herein, the term “about” encompasses +/−5% of a numerical value. For example, if the numerical value is “about 5,” the range of 4.75 to 5.25 is encompassed. Accordingly, unless indicated to the contrary, the numerical parameters set forth in the following specification and attached claims are approximations that may vary depending upon the desired properties sought to be obtained by the exemplary embodiments described herein. At the very least, and not as an attempt to limit the application of the doctrine of equivalents to the scope of the claim, each numerical parameter should at least be construed in light of the number of reported significant digits and by applying ordinary rounding techniques.

While compositions and methods are described herein in terms of “comprising” various components or steps, the compositions and methods can also “consist essentially of” or “consist of” the various components and steps. When “comprising” is used in a claim, it is open-ended.

As used herein, the term “substantially” means largely, but not necessarily wholly.

The use of directional terms such as above, below, upper, lower, upward, downward, left, right, uphole, downhole and the like are used in relation to the illustrative embodiments as they are depicted in the figures herein, the upward direction being toward the top of the corresponding figure and the downward direction being toward the bottom of the corresponding figure, the uphole direction being toward the surface of the well and the downhole direction being toward the toe of the well. Additionally, the embodiments depicted in the figures herein are not necessarily to scale and certain features are shown in schematic form only or are exaggerated or minimized in scale in the interest of clarity.

The hook-and-latch mechanisms described herein improve overall the integrity of formation faces (and the minerals forming such faces) to introduced and produced fluids, such as stimulation treatment fluids. As used herein, the term “treatment fluid,” and grammatical variants thereof, refers generally to any fluid that may be used in a subterranean application in conjunction with a desired function and/or for a desired purpose. The term “treatment fluid” does not imply any particular action by the fluid or any component thereof. The mechanisms employ a two-component system where the “latch” component is a silyl-modified nucleophile coated onto a face of a subterranean formation (e.g., during a preliminary stimulation stage, such as a pad stage), and the “hook” component are proppant particulates coated with an orthogonally reactive electrophile that chemically bonds to the silyl-modified nucleophile (that was coated onto a face of the subterranean formation) to form a monolayer of proppant particulates on the face. As used herein, the term “coating,” and grammatical variants thereof, refers to deposition of the silyl-modified nucleophile on a face of a fracture or deposition of the orthogonally reactive electrophile on the proppant particulates, resulting in a substantially uniform surface of silane on the applicable surface. The coating may be a high degree of surface functionalization (e.g., about >20% coverage, which may be up to 500 micrometers or 1000 micrometers, for example) to a thin-film coating, defined as a coating or film of material that ranges in thickness of from about 0.2 nanometers to about 100 micrometers. The thin-film coating may be a thickness of a few atoms (e.g., 2 or more) on a substrate surface (e.g., formation face, rock, mineral, etc.) to be coated, as well as onto previously deposited molecules forming layers of coating. As used herein, the term “orthogonally reactive,” and grammatical variants thereof, refers to a reaction that occurs within a subterranean formation without interfering with native chemical processes of the subterranean formation, or without interfering with chemical processes presented in the stimulation of, production of, or flowback fluids (both aqueous and organic) from the subterranean formation.

Each of the components is relatively latent and only activated when contacted together or otherwise in close proximity to each other (e.g., in solution). Accordingly, the hook-and-latch mechanism is on-demand and self-propelled to facilitate self-assembly of the coated proppant particulates to the face of the fracture to form a monolayer. Activation of the hook-and-latch mechanisms described herein may be achieved in the presence of one or more downhole activating environments, such as at formation temperature, or in the presence of an electron-generating compound, or any combination thereof. The monolayer formed stabilizes unconsolidated formation fines, protects the face from subsequent treatment fluids and/or production fluids which can degrade the formation and create unconsolidated particulates, provides a monolayer for holding open fractures and/or microfractures upon removal of hydraulic pressure from the formation, provides a means to prevent settling (or “sag”) of proppant, and provides a means to prevent proppant embedment within a formation.

The silyl-modified nucleophiles described herein (the “hook”) serve to provide formation stabilization upon being coated thereon, such as by preventing or reducing swelling of formation components (e.g., clays) and because of its low-viscosity nature can effectively treat long intervals of one or more formation faces, thus allowing deeper stabilization within a wellbore from the surface and/or penetrating radially into a reservoir. The silyl-modified nucleophile is able to form a chemical bond and allow for a coating (e.g., a thin-film coating) onto the formation face(s). The reaction of the silyl-modified nucleophile with the formation face(s) employs physical and chemical forces, such as the formation of a covalent bond between the silyl-modified nucleophile with the formation face(s). The proppant particulates of the present disclosure are pre-coated before their introduction into a subterranean formation with one or more orthogonally reactive electrophile(s) described herein (the “latch”), which upon activation of both components forms a chemical bond (e.g., physical and chemical forces, such as a covalent bond) to the silyl-modified nucleophile, allowing self-assembly of the coated proppant into the monolayer.

In some embodiments, the present disclosure provides a method comprising introducing a stabilizing treatment fluid into a subterranean formation, where the stabilizing treatment fluid comprises a base fluid and a silyl-modified nucleophile. One or more face(s) of the subterranean formation (e.g., the face of the wellbore, the face of one or more fractures, and the like, and any combination thereof) may be coated with the stabilizing treatment fluid (e.g., contacted with or flowed thereupon) to form a chemical bond between the formation face and the silyl-modified nucleophile. Thereafter, a proppant treatment fluid is introduced into the subterranean formation, where the proppant treatment fluid comprises a base fluid and either pre-coated proppant particulates coated with an orthogonally reactive electrophile, or separate non-coated proppant particulates and the orthogonally reactive electrophile (for “on-the-fly” coating). Finally, at least a portion of the silyl-modified nucleophile coated onto the face of the formation and at least a portion of the orthogonally reactive electrophile (pre-coated or on-the-fly coated onto the proppant particulates) react and chemically bond together, thereby forming a monolayer of proppant particulates on the face of the formation. As used herein, the term “at least a portion,” and grammatical variants thereof, refers to forming a chemical bond between at least about 0.001% of the introduced silyl-modified nucleophile and at least about 0.001% of the introduced orthogonally reactive electrophile, up to a 100% combination of the reactive partners. In some embodiments, accordingly, the term the term “at least a portion” refers to forming a chemical bond between at least about 20% of the introduced silyl-modified nucleophile and at least about 20% of the introduced orthogonally reactive electrophile, up to a 100% combination of the reactive partners.

Although some embodiments of the present disclosure are described with reference to stimulation operations (e.g., hydraulic fracturing and/or matrix stimulation), any other subterranean formation operation that may benefit from the self-assembled monolayer formation described herein may be used in accordance with the present disclosure. Other subterranean formation operations that may use the embodiments described herein may include, but are not limited to, re-fracturing operations (e.g., to add newly optimized perforated zones and initiate dominate fracture geometry), remedial treatments, completion operations, production operations, and the like, without departing from the scope of the present disclosure.

When hydraulic fracturing operations are performed in conjunction with the present disclosure, one or both of the stabilizing treatment fluid and/or the proppant treatment fluid are introduced into the subterranean formation at or above the fracture gradient of the formation, thereby creating or extending at least one fracture therein. As used herein, the term “fracture gradient,” and grammatical variants thereof, refers to the pressure required to induce fractures in a subterranean formation at a given depth. In preferred embodiments, at least the stabilizing treatment fluid is introduced into the formation at or above the fracture gradient to create or enhance at least one fracture therein. In yet other embodiments, additional treatment fluids are introduced before the stabilizing treatment fluid, between the stabilizing treatment fluid and the proppant treatment fluid, and/or after the proppant treatment fluid at any pressure (at, above, or below the fracture gradient) and may have none or one or more additives to achieve performance of a particular subterranean formation operation, without departing from the scope of the present disclosure.

Moreover, the formation of at least one fracture by any means may be one or more dominate fracture(s) and/or one or more microfractures that interconnect directly or indirectly to the dominate fracture(s). As used herein, the term “dominate fracture,” and grammatical variants thereof, refers to a primary fracture extending from a wellbore. A “microfracture,” and grammatical variants thereof, as used herein, refers to any fracture extending from a dominate fracture or extending from any non-dominate fracture (e.g., a secondary branch fracture, a tertiary branch fracture, and the like). That is, a secondary branch fracture is a microfracture extending from a dominate fracture. A tertiary branch fracture is a microfracture that extends from a secondary branch fracture. Microfractures, regardless of the type of fracture from which they originate, have a flow channel width or flow opening size of less than that of the dominate fracture or non-dominate fracture from which it extends. The microfractures may be cracks, slots, conduits, perforations, holes, or any other ablation within the formation. As used herein, the term “fracture” refers collectively to dominate fractures and microfractures, unless otherwise specified.

Accordingly, the embodiments described herein overall improve the integrity of formation minerals and stimulation or other subterranean formation operation equipment. Any type of subterranean formation may be used for stimulation and production of a hydrocarbon therefrom may be used in accordance with the embodiments described herein, provided that the silyl-modified nucleophile selected is able to chemically bond thereto. Similarly, any type and size of proppant particulates may be coated with the orthogonally reactive electrophile, provided that it is able to chemically bond therewith.

For example, in some embodiments, the present disclosure entails the formation of chemical bonds between a silane-based compound and an inorganic surface, including the face(s) of the formation and/or the proppant particulates. Such chemical bonding is facile in water and at a broad pH range. For example, silica, quartz, glass, aluminum, copper, alumina, inorganics (e.g., aluminosilicates, inorganic oxides, and the like present in a subterranean formation), mica, talc, steel, iron, asbestos, and nickel exhibit good to excellent silane-based compound affinity. Accordingly, materials having these elements, or at least a detectable amount of one or more of the elements, are preferred for the composition of the subterranean formation and/or the proppant particulates. As used herein, the term “detectable amount,” and grammatical variants thereof, refers to the minimum concentration that can be measured and reported with 99% confidence that the siloxane, ester, anhydride, carbonyl concentration is greater than zero and is determined from analysis of a sample in a given matrix containing the chemical functionality being identified. For example, siliceous formations are particularly suitable, and shale comprises large amounts of quartz. In some embodiments, both the proppant particulates and the subterranean formation are predominately compositional siliceous, defined as being at least about 50% siliceous. As used herein, the term “siliceous,” and grammatical variants thereof, refers to a substance having the characteristics of silica, including silicates and/or alumino-silicates.

The size of the selected proppant particulates may depend on the type of subterranean formation, the size and shape of the fracture face for forming a monolayer (e.g., a dominate fracture(s), a microfracture(s), and the like), the type of orthogonally reactive electrophile selected, and the like, and any combination thereof. Accordingly, the proppant particulates may be selected from the group consisting of macroparticulates, microparticulates, nanoparticulates, and any combination thereof. As used herein, the term “proppant” or “proppant particulates” encompasses collectively each of the macroparticulates, microparticulates, and nanoparticulates, unless otherwise specifically stated.

The macroparticulates may have a unit mesh size in the range of 100 micrometers (μm) to about 1200 μm (e.g., 70-140 U.S. Sieve Series Mesh, 16-30 U.S. Sieve Series Mesh), encompassing any value and subset therebetween. As used herein, the term “unit mesh size,” and grammatical variants thereof, refers to a size of an object (e.g., a proppant) that is able to pass through a square area having each side thereof equal to the specified numerical value provided herein. The microparticulates described herein may have a unit mesh size in the range of 0.1 μm to 100 μm, encompassing any value and subset therebetween. Finally, the nanoparticulates may have a unit mesh size in the range of about 0.001 μm to 0.1 μm, encompassing any value and subset therebetween. In preferred embodiments, a complex fracture network is treated in accordance with the embodiments described herein and the proppant particulates are at least microparticulates, at least nanoparticulates, or at least a combination of nanoparticulates and microparticulates.

The shape of the various proppant particulates described herein may be of any shape capable of meeting the desired unit mesh size or unit mesh size range, as described above. For example, the proppant may be substantially spherical, fibrous, or polygonal in shape. As used herein, the term “substantially spherical,” and grammatical variants thereof, refers to a material that has a morphology that includes spherical geometry and elliptic geometry, including oblong spheres, ovoids, ellipsoids, capsules, and the like and may have surface irregularities. As used herein, the term “fibrous,” and grammatical variants thereof, refers to fiber-shaped substances having aspect ratios of greater than about 5 to an unlimited upper limit. The term “polygonal,” and grammatical variants thereof, as used herein, refers to shapes having at least two straight sides and angles. Examples of polygonal proppant may include, but are not limited to, a cube, cone, pyramid, cylinder, rectangular prism, cuboid, triangular prism, icosahedron, dodecahedron, octahedron, pentagonal prism, hexagonal prism, hexagonal pyramid, and the like, and any combination thereof.

Examples of suitable materials for forming the proppant particulates of the present disclosure include any (or combinations) of the examples above having an affinity to silane, or may include, but are not limited to, sand, ceramic materials, glass materials, polymer materials (e.g., polystyrene, polyethylene, etc.), nut shell pieces, wood, cements (e.g., Portland cements), fly ash, drill cuttings, carbon black powder, silica, alumina, alumino-silicates, fumed carbon, carbon black, graphite, mica, titanium dioxide, barite, meta-silicate, calcium silicate, calcium carbonate, dolomite, nepheline syenite, feldspar, pumice, volcanic material, kaolin, talc, zirconia, boron, shale, clay, sandstone, mineral carbonates, mineral oxide, iron oxide, formation minerals, waste stream sources, man-made materials, low-quality manufactured materials, any of the aforementioned mixed with a resin to form cured resinous particulates, and any combination thereof. As used herein, the term “sand” refers to naturally occurring granular material composed of rock and mineral particulates (e.g., desert sand, beach sand). Nut shells may be from any fruit consisting of a hard or tough shell (encompassing seed and pit shells) including, but not limited to, pecan, walnut, pine, hazelnut, chestnut, acorn, brazil, candlenut, coconut, cashew, pistachio, and the like, and any combination thereof. The term “ceramic material” includes any inorganic crystalline material, compounded of a metal and a non-metal. Examples of suitable ceramics for use as the micro-proppant and/or proppant particulates herein include, but are not limited to, silicon carbide, cordierite, porcelain, alumina porcelain, high-voltage porcelain, lithia porcelain, cordierite refractory, alumina silica refractory, magnesium silicate, steatite, forsterite, titania, tatanate, and any combination thereof.

Each of the silyl-modified nucleophile and the orthogonally reactive electrophiles is introduced into a subterranean formation in a treatment fluid comprising a base fluid. The base fluids for use in forming the treatment fluids described herein (i.e., the stabilizing treatment fluid and the proppant treatment fluid) may include, but are not limited to, aqueous-based fluids, aqueous-miscible fluids, and any combination thereof. Suitable aqueous-based fluids may include fresh water, saltwater (e.g., water containing one or more salts dissolved therein), brine (e.g., saturated salt water), seawater, wastewater, produced water, and any combination thereof. Suitable aqueous-miscible fluids may include, but not be limited to, alcohols (e.g., methanol, ethanol, n-propanol, isopropanol, n-butanol, sec-butanol, isobutanol, and t-butanol), glycerins, glycols (e.g., polyglycols, propylene glycol, and ethylene glycol), polyglycol amines, polyols, any derivative thereof, any in combination with salts (e.g., sodium chloride, calcium chloride, calcium bromide, zinc bromide, potassium carbonate, sodium formate, potassium formate, cesium formate, sodium acetate, potassium acetate, calcium acetate, ammonium acetate, ammonium chloride, ammonium bromide, sodium nitrate, potassium nitrate, ammonium nitrate, ammonium sulfate, calcium nitrate, sodium carbonate, and potassium carbonate), any in combination with an aqueous-based fluid, and any combination thereof.

In some embodiments, the silyl-modified nucleophile may be one of a silyl-modified anhydride, a silyl-modified azide, or a silyl-modified acrylate. In some embodiments, the siloxane moiety covalently attached/bonded to any electrophilic or nucleophile partner is suitable for use in the present disclosure. In some specific embodiments, for example, the acrylate species could be obtain from a coupling reaction in which acryloyl chloride, acryloyl anhydride, acrylamide, or acryloyl acid is treated with a nucleophilic species of the silyloxy moiety X—Cₙ—Si(OYₘHᵣ)₃, where X is defined as —SH, —NH₂, or —OH; C is defined as a methylene unit with n representing the number of methylene units between 1 and 5; Y represents Carbon with m being an integer between 1 and 3; and H represents Hydrogen with r being an integer between 3 and 7 depending on the length of the alkyl chain bonded to the silyoxy moiety. The process would also be the same if the silyloxy-modified acrylate or acrylamide or thioester became the nucleophilic species and the silyloxy species would be Z—Cₙ—Si(OYₘHᵣ)3, where Z is defined as any electrophilic moiety (in organic chemistry known as the leaving group in a nucleophilic substitution) which encompasses halogens, tosylates, mesylates, and glycidylethers; C is defined as a methylene unit with n representing the number of methylene units between 1 and 5; Y represents Carbon and with m being an integer between 1 and 3; and H represents Hydrogen with r being an integer between 3 and 7 depending on the length of the alkyl chain bonded to the silyoxy moiety. The orthogonally reactive nucleophile may be one of an orthogonally reactive diamine, an orthogonally reactive alkyne, or an orthogonally reactive vinyl silane.

Typically, the ratio of the silyl-modified nucleophile in the stabilizing treatment fluid to the orthogonally reactive electrophile in the proppant treatment fluid is in the range of 99.9:0.1 to 0.1:99.9, encompassing any value and subset therebetween. In other embodiments, the ratio of the silyl-modified nucleophile in the stabilizing treatment fluid to the orthogonally reactive electrophile in the proppant treatment fluid is in the range of 1:5 to 5:1, encompassing any value and subset therebetween. In still other embodiments, the ratio of the silyl-modified nucleophile in the stabilizing treatment fluid to the orthogonally reactive electrophile in the proppant treatment fluid is 1:1 (i.e., equimolar), encompassing any value and subset therebetween.

The chemical bonding of the silyl-modified nucleophile and the orthogonally reactive electrophile may be activated at formation temperature and/or in the presence of an electron-generating compound. Typical formation temperatures for forming the chemical bond between the silyl-modified nucleophile and the orthogonally reactive electrophile described herein may be in the range of 25° C. to 150° C., encompassing any value and subset therebetween. The electron-generating agent may include, but not be limited to, ultraviolet radiation, an oxidizing compound, and any combination thereof.

The ultraviolet radiation may be supplied by means of an ultraviolet radiation source (e.g., a bulb or lamp) that is supplied downhole into the subterranean formation, such as via a downhole tool or forming a portion of a downhole tool. When the selected electron-generating agent is an oxidizing chemical, it may be introduced into the formation along with the proppant treatment fluid, along with the stabilizing treatment fluid, and/or as a secondary flush treatment fluid following introduction of the proppant treatment fluid. Suitable oxidizing compounds include, but are not limited to, organic peroxides, alkali metal persulfates, and alkali metal chlorites, bromates, chlorates, hypochlorites, permanganates, and any combination thereof.

In one embodiment, the silyl-modified nucleophile selected is a silyl-modified anhydride and the orthogonally reactive electrophile is an orthogonally reactive diamine, and the chemical bonding between the silyl-modified anhydride and the orthogonally reactive diamine occurs at formation temperature, due to the elevated temperatures therein, as described above. In such embodiments, the silane-based functionality of the silyl-modified anhydride will chemically bond to coat a formation face and the anhydride moiety remains relatively nonreactive. Similarly, the orthogonally reactive diamine chemically bonds to proppant particulates and upon introduction of the proppant treatment fluid, the diamine (“hook”) is exposed to the anhydride (“latch”) and the two moieties selectively react to form a chemical bond. A monolayer of the proppant particulates is thus formed on the formation face (e.g., on the face of a dominate fracture and/or microfracture). The mode of reactivity in this embodiment is amide formation and is a facile process at formation temperature, resulting in a robust amide bond. A specific example of the reaction process of when the silyl-modified nucleophile selected is a silyl-modified anhydride and the orthogonally reactive electrophile selected is an orthogonally reactive diamine is shown as Scheme I below. The proppant surface and the formation surface are labeled and indicated with a wavy line.

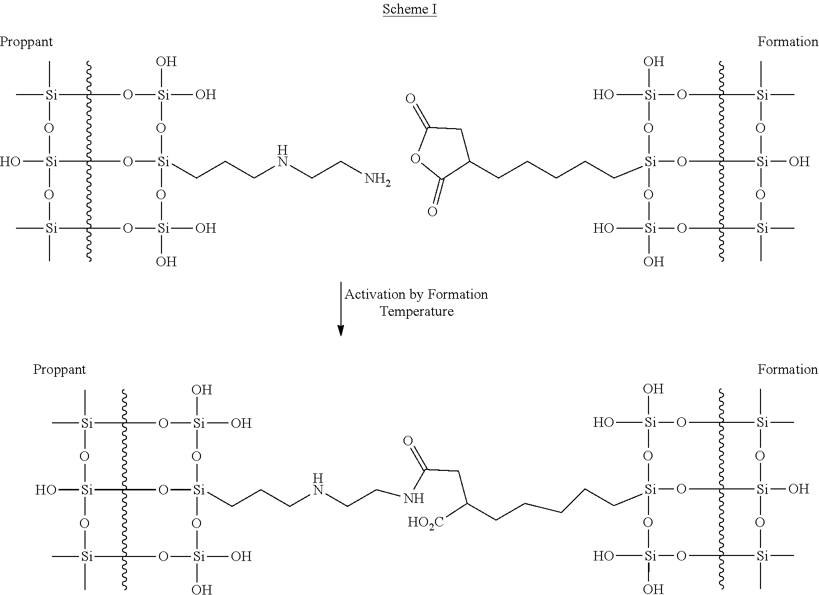

In another embodiment, the silyl-modified nucleophile selected is a silyl-modified azide and the orthogonally reactive electrophile is an orthogonally reactive alkyne, and the chemical bonding between the silyl-modified azide and the orthogonally reactive alkyne occurs at formation temperature, due to the elevated temperatures therein, as described above. In such embodiments, the silane-based functionality of the silyl-modified anhydride will chemically bond to coat a formation face and the azide moiety remains relatively nonreactive. Similarly, the orthogonally reactive alkyne chemically bonds to proppant particulates and upon introduction of the proppant treatment fluid, the alkyne (“hook”) is exposed to the azide (“latch”) and the two moieties selectively react to form a chemical bond. A monolayer of the proppant particulates is thus formed on the formation face (e.g., on the face of a dominate fracture and/or microfracture). The mode of reactivity in this embodiment is cycloaddition (or “click” chemistry activation) resulting in heterocycle formation and is a facile process at formation temperature, resulting in a robust heterocycle bond. The heterocycle formation further imparts mechanical stability to the monolayer. For example, heterocycles may act as shale and/or clay stabilizers, which prevent mechanical damage to formation faces due to exposure to stimulation fluids and produced fluids. A specific example of the reaction process of when the silyl-modified nucleophile selected is a silyl-modified azide and the orthogonally reactive electrophile selected is an orthogonally reactive alkyne is shown as Scheme II below. The proppant surface and the formation surface are labeled and indicated with a wavy line.

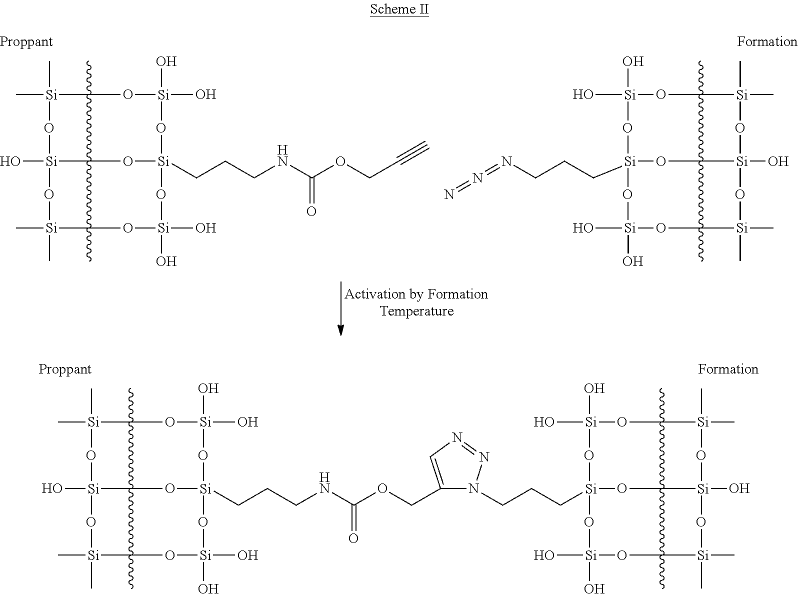

As another specific embodiment, the silyl-modified nucleophile selected is a silyl-modified acrylate and the orthogonally reactive electrophile is an orthogonally reactive vinyl silane, and the chemical bonding between the silyl-modified acrylate and the orthogonally reactive vinyl silane occurs at formation temperature and in the presence of an electron-generating compound, as described above. In such embodiments, the silane-based functionality of the silyl-modified acrylate will chemically bond to coat a formation face and the acrylate moiety (e.g., an acrylate ester) remains relatively nonreactive. Similarly, the orthogonally reactive vinyl silane chemically bonds to proppant particulates and upon introduction of the proppant treatment fluid, the vinyl silane (“hook”) is exposed to the acrylate (“latch”) and the two moieties selectively react to form a chemical bond. A monolayer of the proppant particulates is thus formed on the formation face (e.g., on the face of a dominate fracture and/or microfracture). The mode of reactivity in this embodiment is polymerization and is a facile process at formation temperature and in the presence of a suitable electron-generating compound. Such resultant polymeric compounds are robust and may impart mechanical stability to the monolayer. A specific example of the reaction process of when the silyl-modified nucleophile selected is a silyl-modified acrylate and the orthogonally reactive electrophile selected is an orthogonally reactive vinyl silane is shown as Scheme III below. The proppant surface and the formation surface are labeled and indicated with a wavy line.

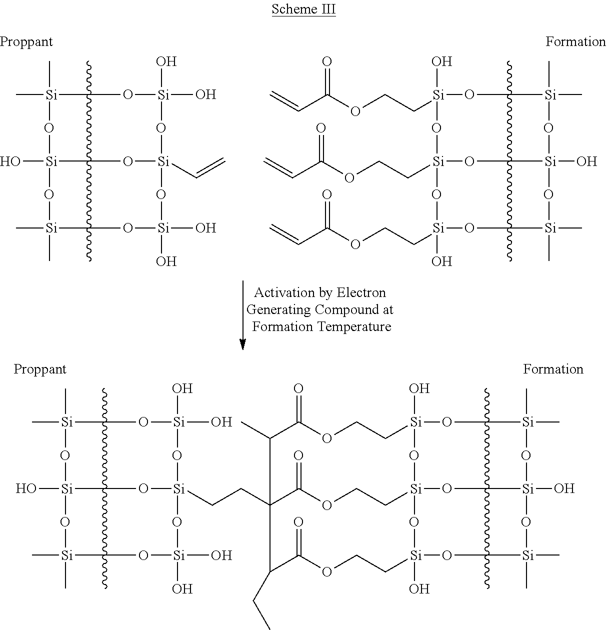

Additional additives may be included in any of the treatment fluids described herein, such as to achieve a particular subterranean formation, provided that they do not interfere with the hook-and-latch stabilization properties described herein. Examples of such additives may include, but are not limited to, a salt, a weighting agent, an inert solid, a fluid loss control agent, an emulsifier, a dispersion aid, a corrosion inhibitor, an emulsion thinner, an emulsion thickener, a viscosifying agent, a gelling agent, a surfactant, a particulate, a proppant, a gravel particulate, a lost circulation material, a foaming agent, a gas, a pH control additive, a breaker, a biocide, a crosslinker, a stabilizer, a chelating agent, a scale inhibitor, a gas hydrate inhibitor, a mutual solvent, an oxidizer, a reducer, a friction reducer, a clay stabilizing agent, and any combination thereof.

In various embodiments, systems configured for delivering the treatment fluids (e.g., the stabilizing treatment fluid and the proppant treatment fluid) described herein to a downhole location are described. In various embodiments, the systems can comprise a pump fluidly coupled to a tubular, the tubular containing the treatment fluids described herein. It will be appreciated that while the system described below may be used for delivering any one of the treatment fluids described herein, each treatment fluid is delivered separately into the subterranean formation, unless otherwise indicated.

The pump may be a high pressure pump in some embodiments. As used herein, the term “high pressure pump” will refer to a pump that is capable of delivering a treatment fluid downhole at a pressure of about 1000 psi or greater. A high pressure pump may be used when it is desired to introduce the treatment fluids to a subterranean formation at or above a fracture gradient of the subterranean formation, but it may also be used in cases where fracturing is not desired. In some embodiments, the high pressure pump may be capable of fluidly conveying particulate matter, such as the particulates described in some embodiments herein, into the subterranean formation. Suitable high pressure pumps will be known to one having ordinary skill in the art and may include, but are not limited to, floating piston pumps and positive displacement pumps.

In other embodiments, the pump may be a low pressure pump. As used herein, the term “low pressure pump” will refer to a pump that operates at a pressure of about 1000 psi or less. In some embodiments, a low pressure pump may be fluidly coupled to a high pressure pump that is fluidly coupled to the tubular. That is, in such embodiments, the low pressure pump may be configured to convey the treatment fluids to the high pressure pump. In such embodiments, the low pressure pump may “step up” the pressure of the treatment fluids before reaching the high pressure pump.

In some embodiments, the systems described herein can further comprise a mixing tank that is upstream of the pump and in which the treatment fluids are formulated. In various embodiments, the pump (e.g., a low pressure pump, a high pressure pump, or a combination thereof) may convey the treatment fluids from the mixing tank or other source of the treatment fluids to the tubular. In other embodiments, however, the treatment fluids may be formulated offsite and transported to a worksite, in which case the treatment fluid may be introduced to the tubular via the pump directly from its shipping container (e.g., a truck, a railcar, a barge, or the like) or from a transport pipeline. In either case, the treatment fluids may be drawn into the pump, elevated to an appropriate pressure, and then introduced into the tubular for delivery downhole.

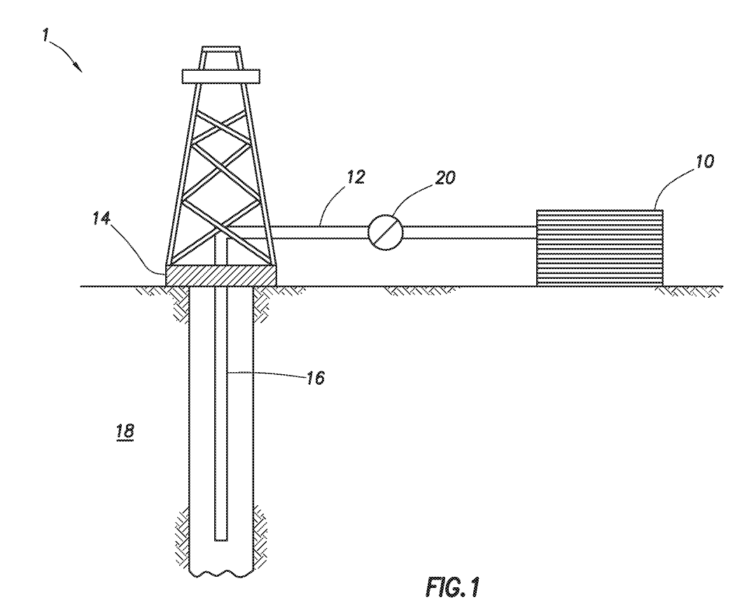

FIG. 1 shows an illustrative schematic of a system that can deliver the treatment fluids of the present disclosure to a downhole location, according to one or more embodiments. It should be noted that while FIG. 1 generally depicts a land-based system, it is to be recognized that like systems may be operated in subsea locations as well. As depicted in FIG. 1, system 1 may include mixing tank 10, in which the treatment fluids of the embodiments herein may be formulated. The treatment fluids may be conveyed via line 12 to wellhead 14, where the treatment fluids enter tubular 16, tubular 16 extending from wellhead 14 into subterranean formation 18. Upon being ejected from tubular 16, the treatment fluids may subsequently penetrate into subterranean formation 18. Pump 20 may be configured to raise the pressure of the treatment fluids to a desired degree before introduction into tubular 16. It is to be recognized that system 1 is merely exemplary in nature and various additional components may be present that have not necessarily been depicted in FIG. 1 in the interest of clarity. Non-limiting additional components that may be present include, but are not limited to, supply hoppers, valves, condensers, adapters, joints, gauges, sensors, compressors, pressure controllers, pressure sensors, flow rate controllers, flow rate sensors, temperature sensors, and the like.

Although not depicted in FIG. 1, the treatment fluid or a portion thereof may, in some embodiments, flow back to wellhead 14 and exit subterranean formation 18. In some embodiments, the treatment fluid that has flowed back to wellhead 14 may subsequently be recovered and recirculated to subterranean formation 18, or otherwise treated for use in a subsequent subterranean operation or for use in another industry.

It is also to be recognized that the disclosed treatment fluids may also directly or indirectly affect the various downhole equipment and tools that may come into contact with the treatment fluids during operation. Such equipment and tools may include, but are not limited to, wellbore casing, wellbore liner, completion string, insert strings, drill string, coiled tubing, slickline, wireline, drill pipe, drill collars, mud motors, downhole motors and/or pumps, surface-mounted motors and/or pumps, centralizers, turbolizers, scratchers, floats (e.g., shoes, collars, valves, etc.), logging tools and related telemetry equipment, actuators (e.g., electromechanical devices, hydromechanical devices, etc.), sliding sleeves, production sleeves, plugs, screens, filters, flow control devices (e.g., inflow control devices, autonomous inflow control devices, outflow control devices, etc.), couplings (e.g., electro-hydraulic wet connect, dry connect, inductive coupler, etc.), control lines (e.g., electrical, fiber optic, hydraulic, etc.), surveillance lines, drill bits and reamers, sensors or distributed sensors, downhole heat exchangers, valves and corresponding actuation devices, tool seals, packers, cement plugs, bridge plugs, and other wellbore isolation devices, or components, and the like. Any of these components may be included in the systems generally described above and depicted in FIG. 1.

While various embodiments have been shown and described herein, modifications may be made by one skilled in the art without departing from the scope of the present disclosure. The embodiments described here are exemplary only, and are not intended to be limiting. Many variations, combinations, and modifications of the embodiments disclosed herein are possible and are within the scope of the disclosure. Accordingly, the scope of protection is not limited by the description set out above, but is defined by the claims which follow, that scope including all equivalents of the subject matter of the claims.

Embodiments disclosed herein include:

Embodiment A: A method comprising: introducing a stabilizing treatment fluid into a subterranean formation, the stabilizing treatment fluid comprising a first base fluid and a silyl-modified nucleophile; coating a face of the subterranean formation with the stabilizing treatment fluid, wherein the silyl-modified compound chemically bonds to the face of the subterranean formation; introducing a proppant treatment fluid into the subterranean formation, the proppant treatment fluid comprising a second base fluid and proppant particulates coated with an orthogonally reactive electrophile; and chemically bonding at least a portion of the silyl-modified nucleophile with at least a portion of the orthogonally reactive electrophile, thereby forming a monolayer of proppant particulates on the face of the subterranean formation.

Embodiment B: A method comprising: introducing a stabilizing treatment fluid into a subterranean formation at or above a fracture gradient of the subterranean formation thereby creating or extending at least one fracture therein, the stabilizing treatment fluid comprising a first base fluid and a silyl-modified nucleophile; coating a face of the at least one fracture with the stabilizing treatment fluid, wherein the silyl-modified compound chemically bonds to the face of the at least one fracture; introducing a proppant treatment fluid into the subterranean formation, the proppant treatment fluid comprising a second base fluid and proppant particulates coated with an orthogonally reactive electrophile; chemically bonding at least a portion of the silyl-modified nucleophile with at least a portion of the orthogonally reactive electrophile, thereby forming a monolayer of proppant particulates on the face of the at least one fracture.

Each of Embodiments A and B and may have one or more of the following additional elements in any combination:

Element 1: Wherein the proppant particulates are selected from the group consisting of macroparticulates, microparticulates, nanoparticulates, and any combination thereof, wherein the macroparticulates have a unit mesh size in the range of 100 micrometers to about 1200 micrometers, wherein the microparticulates have a unit mesh size in the range of 0.1 micrometers to 100 micrometers, and wherein the nanoparticulates have a unit mesh size in the range of about 0.001 micrometers to 0.1 micrometers.

Element 2: Wherein the subterranean formation and the proppant particulates are predominately compositionally siliceous.

Element 3: Wherein the silyl-modified nucleophile is a silyl-modified anhydride and the orthogonally reactive electrophile is an orthogonally reactive diamine, and wherein chemically bonding the silyl-modified anhydride and the orthogonally reactive diamine occurs at formation temperature.

Element 4: Wherei the silyl-modified nucleophile is a silyl-modified azide and the orthogonally reactive electrophile is an orthogonally reactive alkyne, and wherein chemically bonding the silyl-modified azide and the orthogonally reactive alkyne occurs at formation temperature.

Element 5: Wherein the silyl-modified nucleophile is a silyl-modified acrylate and the orthogonally reactive electrophile is an orthogonally reactive vinyl silane, and further comprising introducing an electron-generating agent into the subterranean formtion, wherein chemically bonding the silyl-modified acrylate and the orthogonally reactive vinyl silane occurs at formation temperature and in the presence of the electron-generating compound.

Element 6: Wherein the electron-generating agent is selected from the group consisting of ultraviolent radiation, an oxidizing compound, and any combination thereof.

Element 7: The ratio of the silyl-modified nucleophile in the stabilizing treatment fluid to the orthogonally reactive electrophile in the proppant treatment fluid is in the range of 1:5 to 5:1.

Element 8: Wherein the subterranean formation has a formation temperature in the range of from 25° C. to 150° C.

Element 9: Further comprising a pump fluidly coupled to a tubular extending into the subterranean formation, and wherein the tubular contains a fluid selected from the group consisting of the stabilizing treatment fluid, the proppant treatment fluid, and any combination thereof.

By way of non-limiting example, exemplary combinations applicable to A and/or B include: 1-9; 1, 3, and 8; 2 and 9; 4, 5, and 7; 3, 4, 8, and 9; 2 and 6; 1, 4, 6, and 8; 7, 8, and 9; and any combination of 1-9 in any order, without limitation.

Therefore, the embodiments disclosed herein are well adapted to attain the ends and advantages mentioned as well as those that are inherent therein. The particular embodiments disclosed above are illustrative only, as they may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrativ embodiments disclosed above may be altered, combined, or modified and all such variations are considered within the scope and spirit of the present disclosure. The embodiments illustratively disclosed herein suitably may be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces.

What is claimed is:

1. A method comprising:
introducing a stabilizing treatment fluid into a subterranean formation, the stabilizing treatment fluid comprising a first base fluid and a silyl-modified nucleophile;
coating a face of the subterranean formation with the stabilizing treatment fluid, wherein the silyl-modified compound chemically bonds to the face of the subterranean formation;
introducing a proppant treatment fluid into the subterranean formation, the proppant treatment fluid comprising a second base fluid and proppant particulates coated with an orthogonally reactive electrophile; and
chemically bonding at least a portion of the silyl-modified nucleophile with at least a portion of the orthogonally reactive electrophile, thereby forming a monolayer of proppant particulates on the face of the subterranean formation.

2. The method of claim 1, wherein the pr
oppant particulates are selected from the group consisting of macroparticulates, microparticulates, nanoparticulates, and an
y combination thereof, wherein the macroparticulates have a unit mesh size in the range of 100 micrometers to abou
t 1200 micrometers, wherein the microparticulates have a unit mesh size in the range of 0.1 micrometers to 100 micrometers, and wherein the nanoparticulates have a unit mesh size in the range of about 0.001 micrometers to 0.1 micrometers.

3. The method of claim 1, wherein the subterranean formation and the roppant p articulates are predominately compositionally siliceous.

4. The method of claim 1, wherein the silyl-modified nucleophile is a silyl-modified anhydride and the orthogonally reactive electrophile is an orthogonally reactive iamine, and wherein chemically bonding the silyl-modified anhydride and the orthgonally r eactive diamine occurs at formation temperature.

5. The method of claim 1, wherein the silyl-modified nucleophile is a silyl-modified azide and the orthogonally reactive electrophile is an orthogonally reactive alkyne, and wherein chemiclly bonding the silyl-modified azide and the orthogonally reactive alkyne occurs at formation temperature.

6. The method of claim 1, wherein the silyl-modified nucleophile is a silyl-modified acrylate and the orthogonally reactive eectrophile is an orthogonally reactive vinyl silane, and further comprising introducing an electron-generating agent into the subterranean formation, wherein chemically bonding the silyl-modified acrylate and the orthogonally reactive vinyl silane occurs at formation temperature and in the presence of the electron-generating compound.

7. The method of claim 6, wherein the electron-generating agent is selected from the group consisting of ultraviolent radiation, an oxidizing compound, and any combination thereof.

8. The method of claim 1, the ratio of the silyl-modified nucleophile in the stabilizing treatment fluid to the orthogonally reactive electrophile in the proppant treatment fluid is in the range of 1:5 to 5:1.

9. The method of claim 1, wherein the subterranean formation has a formation temperature in the range of from 25° C. to 150° C.

10. The method of claim 1, further comprising a pump fluidly coupled to a tubular extending into the subterranean formation, and wherein the tubular contains a fluid selected from the group consisting of the stabilizing treatment fluid, the proppant treatment fluid, and any combination thereof.

11. A method comprising:
introducing a stabilizing treatment fluid into a subterranean formation at or above a fracture gradient of the subterranean formation thereby creating or extending at least one fracture therein, the stabilizing treatment fluid comprising a first base fluid and a silyl-modified nucleophile;
coating a face of the at least one fracture with the stabilizing treatment fluid, wherein the silyl-modified compound chemically bonds to the face of the at least one fracture;
introducing a proppant treatment fluid into the subterranean formation, the proppant treatment fluid comprising a second base fluid and proppant particulates coated with an orthogonally reactive electrophile;
chemically bonding at least a portion of the silyl-modified nucleophile with at least a portion of the orthogonally reactive electrophile, thereby forming a monolayer of proppant particulates on the face of the at least one fracture.

12. The method of claim 11, wherein the proppant particulates are selected from the group consisting of macroparticulates, microparticulates, nanoparticulates, and any combination thereof,
wherein the macroparticulates have a unit mesh size in the range of 100 micrometers to about 1200 micrometers,
wherein the microparticulates have a unit mesh size in the range of 0.1 micrometers to 100 micrometers, and
wherein the nanoparticulates have a unit mesh size in the range of about 0.001 micrometers to 0.1 micrometers.

13. The method of claim 11, wherein the subterranean formation and the proppant particulates are predominately compositionally siliceous.

14. The method of claim 11, wherein the silyl-modified nucleophile is a silyl-modified anhydride and the orthogonally reactive electrophile is an orthogonally reactive diamine, and wherein chemically bonding the silyl-modified anhydride and the orthogonally reactive diamine occurs at formation temperature.

15. The method of claim 11, wherein the silyl-modified nucleophile is a silyl-modified azide and the orthogonally reactive electrophile is an orthogonally reactive alkyne, and wherein chemically bonding the silyl-modified azide and the orthogonally reactive alkyne occurs at formation temperature.

16. The method of claim 11, wherein the silyl-modified nucleophile is a silyl-modified acrylate and the orthogonally reactive electrophile is an orthogonally reactive vinyl silane, and further comprising introducing an electron-generating agent into the subterranean formation, wherein chemically bonding the silyl-modified acrylate and the orthogonally reactive vinyl silane occurs at formation temperature and in the presence of the electron-generating compound.

17. The method of claim 16, wherein the electron-generating agent is selected from the group consisting of ultraviolent radiation, an oxidizing compound, and any combination thereof.

18. The method of claim 11, the ratio of the silyl-modified nucleophile in the stabilizing treatment fluid to the orthogonally reactive electrophile in the proppant treatment fluid is in the range of 1:5 to 5:1.

19. The method of claim 11, wherein the subterranean formation has a formation temperature in the range of from 25° C. to 150° C.

20. The method of claim 11, further comprising a pump fluidly coupled to a tubular extending into the subterranean formation, and wherein the tubular contains a fluid selected from the group consisting of the stabilizing treatment fluid, the proppant treatment fluid, and any combination thereof.
